(19) United States
(12) Patent Application Publication
(10) Pub. No.: US 2017/0213469 A1
(43) Pub. Date: Jul. 27, 2017

(54) DIGITAL MEDIA CONTENT EXTRACTION AND NATURAL LANGUAGE PROCESSING SYSTEM

(71) Applicant: WeSpeke, Inc., Pittsburgh, PA (US)

(72) Inventors: Michael E. ELCHIK, Moon Township, PA (US); Jaime G. Carbonell, Pittsburgh, PA (US); Cathy Wilson, Glenview, IL (US); Robert J. Pawlowski, JR., Cranberry Township, PA (US); Dafyd Jones, Edgeworth, PA (US)

(21) Appl. No.: 15/415,314

(22) Filed: Jan. 25, 2017

Related U.S. Application Data
(60) Provisional application No. 62/286,661, filed on Jan. 25, 2016.
(60) Provisional application No. 62/331,490, filed on May 4, 2016.
(60) Provisional application No. 62/428,260, filed on Nov. 30, 2016.

(51) Int. Cl. G09B 5/02; G06F 17/24; G10L 15/26; G09B 19/06; G06F 17/28; G09B 7/02; G09B 7/06; G06F 17/27; G10L 25/78

(52) U.S. Cl. CPC G09B 5/02; G06F 17/278; G06F 17/2705; G06F 17/248; G10L 15/265; G10L 25/78; G06F 17/28; G09B 7/02; G09B 7/06; G09B 19/06

(57) ABSTRACT

An automated lesson generation learning system extracts text-based content from a digital programming file. The system parses the extracted content to identify one or more topics, parts of speech, named entities and/or other material in the content. The system then automatically generates and outputs a lesson containing content that is relevant to the content that was extracted from the digital programming file.

### CROSS REFERENCE TO RELATED APPLICATIONS

This patent document claims priority to: (1) U.S. Provisional Patent Application No. 62/286,661, filed Jan. 25, 2016; (2) U.S. Provisional Patent Application No. 62/331,490, filed May 4, 2016; and (3) U.S. Provisional Patent Application No. 62/428,260, filed Nov. 30, 2016. The disclosure of each priority application is incorporated into this document by reference.

### BACKGROUND

Cost effective, high quality, culturally sensitive and efficient systems for automatically creating skills development content have evaded the global market for skills development systems. Existing systems for generating content for skills development systems require a significant amount of human time and effort. In order to make the content relevant to a particular learner, the human developers must manually review massive amounts of data. In addition, the technological limitations associated with such systems make them not scalable to be useful with large numbers of learners across the country or around the world, nor do they permit the development of contextually relevant skills development content in real time.

For example, businesses and governments require contextually-relevant language skills from their employees, and leisure travelers desire these skills to move about the world. Currently, language acquisition and language proficiency is accomplished through numerous, disparate methods including but not limited to classroom teaching, individual tutors, reading, writing, and content immersion. However, most content designed for language learning (such as a text book) is not engaging or of particular interest to a language learner, and other forms such as hiring individual tutors can be prohibitively expensive. In addition, limitations in current technology do not require the automatic development of contextually-relevant language learning content in real time. For example, current content development systems are not accurately able to discern the correct meaning of a word that has two possible meanings. (Example: whether the term “bass” refers to a fish or to a musical instrument.) Similarly, current systems are not able to resolve the sense of a word to a standard definition when multiple definitions are available, nor can current systems automatically perform lemmatization of a word (i.e., resolving a word to its base form).

This document describes methods and systems that are directed to solving at least some of the issues described above.

### SUMMARY

In an embodiment, a lesson generation and presentation system includes a digital media server that serves digital programming files to a user's media presentation device. Each of the programming files corresponds to a digital media asset, such as a news report, article, video or other item of content. The system also includes a processor that generates lessons that are relevant to named entities, events, key vocabulary words, sentences or other items that are included in the digital media asset. The system generates each lesson by selecting a template that is relevant to the event, and by automatically populating the template with content that is relevant to the named entity and that is optionally also relevant to one or more attributes of the user. The system may identify the content with which to populate the template by using named entity recognition to extract a named entity from the analyzed content, and also by extracting an event from the content. The system serves the lesson to the user's media presentation device in a time frame that is temporally relevant to the user's consumption of the digital media asset. In some embodiments, the system may only extract the named entity and event from a particular digital media asset and use that asset's content in lesson generation if the content satisfies the one or more screening criteria.

In an alternate embodiment, a lesson generation and presentation system includes a processor that analyzes digital programming files served to a user's media presentation device from one or more digital media servers. Each of the programming files corresponds to a digital media asset, such as a news report, article, video or other item of content. The system generates lessons that are relevant to named entities, events, key vocabulary words, sentences or other items that are included in the digital media asset. The system generates each lesson by selecting a template that is relevant to the event, and by automatically populating the template with named entities, events, and/or other content that is relevant to the named entity and that is optionally also relevant to one or more attributes of the user. The system serves the lesson to the user's media presentation device in a time frame that is temporally relevant to the user's consumption of the digital media asset. In some embodiments, the system may only extract the named entity and event from a particular digital media asset and use that asset's content in lesson generation if the content satisfies the one or more screening criteria.

In an alternate embodiment, a system analyzes streaming video and an associated audio or text channel and automatically generates a learning exercise based on data extracted from the channel. The system may include a video presentation engine configured to cause a display device to output a video served by a video server, a processing device, a content analysis engine and a lesson generation engine. The content analysis engine includes programming instructions that are configured to cause the processing device to extract text corresponding to words spoken or captioned in the channel and identify: (i) a language of the extracted text; (ii) one or more topics; and (iii) one or more sentence characteristics that include one or more named entities or key vocabulary words, one or more parts of speech, or both (or any combination of the above). The lesson generation engine includes programming instructions that are configured to cause the processing device to automatically generate a learning exercise associated with the language. The learning exercise includes at least one question that is relevant to an identified topic, and at least one question or associated answer that includes information pertinent to the sentence characteristic. For example, the question or associated entity may include one or more of the identified named entities, key vocabulary words and/or one or more of the parts of speech. The system will cause a user interface to output the learning exercise to a user in a one-question-at-a-time format. In this way, the system first presents a question, a user may enter a response to the question, and the user interface outputs a next question after receiving each response.

As noted above, the content analysis engine may extract text corresponding to words spoken in the video. To do this, the system may process an audio component of the video with a speech-to-text conversion engine to yield a text output, and it may parse the text output to identify the language of the text output, the named entity, and/or the one or more parts of speech. In addition or alternatively, the system may process a data component of the video that contains encoded closed captions for the video, decode the encoded closed captions to yield a text output, and it may parse the text output to identify the language of the text output, the named entity, and/or the one or more parts of speech.

Optionally, if the lesson generation engine determines that a question in the set of questions will be a multiple-choice question, it may designate the named entity as the correct answer to the question. It may then generate one or more foils, so that each foil is an incorrect answer that is a word associated with an entity category in which the named entity is categorized. The system may generate candidate answers for the multiple-choice question so that the candidate answers include the named entity and the one or more foils. The system may then cause the user interface to output the candidate answers when outputting the multiple-choice question.

The lesson generation engine may also generate foils for vocabulary words. For example, the lesson generation engine may generate a correct definition and one or more foils that are false definitions, in which each foil is an incorrect answer that includes a word associated with a key vocabulary word that was extracted from the content.

Optionally, the lesson generation engine may determine that a question in the set of questions will be a true-false question. If so, then it may include the named entity in the true-false question.

Optionally, the system also may include a lesson administration engine that will, for any question that is a fill-in-the-blank question, cause the system to determine whether the response received to the fill-in-the-blank question is an exact match to a correct response. If the response received to the fill-in-the-blank question is an exact match to a correct response, then the system may output an indication of correctness and advance to a next question. If the response received to the fill-in-the-blank question is not an exact match to a correct response, then the system may determine whether the received response is a semantically related match to the correct response. If the received response is a semantically related match to the correct response, the system may output an indication of correctness and advance to a next question; otherwise, the system may output an indication of incorrectness.

Optionally, the system also may be programmed to analyze a set of responses from a user to determine a language proficiency score for the user. If so, the system may identify an additional video that is available at the remote video server and that has a language level that corresponds to the language proficiency score. The system may cause the video presentation engine to cause a display device to output the additional video as served by the remote video server.

The system also may be programmed to analyze a set of responses from a user to determine a language proficiency score for the user, generate a new question that has a language level that corresponds to the language proficiency score, and cause the user interface to output the new question.

In some embodiments, when extracting the named entity the system may perform multiple extraction methods from text, audio and/or video and use a meta-combiner to produce the extracted named entity.

In some embodiments, when generating the learning exercise the system will only use content from a channel to generate a learning exercise if the content satisfies one or more screening criteria for objectionable content, otherwise it will not use that content asset to generate the learning exercise.

In an alternate embodiment, a system for analyzing streaming video and automatically generating language learning content based on data extracted from the streaming video includes a video presentation engine configured to cause a display device to output a video served by a remote video server, a processing device, a content analysis engine and a lesson generation engine. The content analysis engine is programmed to identify a single sentence of words spoken in the video. The lesson generation engine is programmed to automatically generate a set of questions for a lesson associated with the language. The set of questions includes one or more questions in which content of the identified single sentence is part of the question or the answer to the question. The system will cause a user interface to output the set of questions to a user in a format by which the user interface outputs the questions one at a time, a user may enter a response to each question, and the user interface outputs a next question after receiving each response.

Optionally, to identify a single sentence of words spoken in a video, the system may identify pauses in the audio track having a length that at least equals a length threshold. Each pause may correspond to a segment of the audio track having a decibel level that is at or below a decibel threshold, or a segment of the audio track in which no words are being spoken. The system may select one of the pauses and an immediately subsequent pause in the audio track, and it may process the content of the audio track that is present between the selected pause and the immediately subsequent pause to identify text associated with the content and select the identified text as the single sentence.

### BRIEF DESCRIPTION OF THE DRAWINGS

FIG. 1 illustrates a system that may be used to generate language learning lessons based on content from digital media.

FIG. 2 is a process flow diagram of various elements of an embodiment of a lesson presentation system.

FIGS. 3 and 4 illustrate examples of how content may be created from digital videos.

FIG. 5 illustrates additional process flow examples.

FIG. 6 illustrates additional details of an automated lesson generation process.

FIG. 7 illustrates an example of content from a digital programming file.

FIGS. 8 and 9 illustrate example elements of vocabulary processing.

FIG. 10 illustrates a narrowing down of a vocabulary processing process.

FIG. 11 illustrates a process of selecting words corresponding to a category.

FIG. 12 shows various examples of hardware that may be used in various embodiments.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used in this document, the terms “digital media service” and “video delivery service” refer to a system, including transmission hardware and one or more non-transitory data storage media, that is configured to transmit digital content to one or more users of the service over a communications network such as the Internet, a wireless data network such as a cellular network or a broadband wireless network, a digital television broadcast channel or a cable television service. Digital content may include static content (such as web pages or electronic documents), dynamic content (such as web pages or document templates with a hyperlink to content hosted on a remote server), digital audio files or digital video files. For example, a digital media service may be a news and/or sports programming service that delivers live and/or recently recorded content relating to current events in video format, audio format and/or text format, optionally with images and/or closed-captions. Digital video files may include one or more tracks that are associated with the video, such as an audio channel, and optionally one or more text channels, such as closed captioning.

As used in this document, the terms “digital programming file” and “digital media asset” each refers to a digital file containing one or more units of audio and/or visual content that an audience member may receive from a digital media service and consume (listen to and/or view) on a content presentation device. A digital file may be transmitted as a downloadable file or in a streaming format. Thus, a digital media asset may include streaming media and media viewed via one or more client device applications, such as a web browser. Examples of digital media assets include, for example, videos, podcasts, news reports to be embedded in an Internet web page, and the like.

As used in this document, the term “digital video file” refers to a type of digital programming file containing one or more videos, with audio and/or closed-caption channels that an audience member may receive from a digital video service and view on a content presentation device. A digital video file may be transmitted as a downloadable file or in a streaming format. Examples include, for example, videos, video podcasts, video news reports to be embedded in an Internet web page and the like. Digital video files typically include visual (video) tracks and audio tracks. Digital video files also may include an encoded data component, such as a closed caption track. In some embodiments, the encoded data component may be in a sidecar file that accompanies the digital video file so that, during video playback, the sidecar file and digital video file are multiplexed so that the closed captioning appears on a display device in synchronization with the video.

As used in this document, a “lesson” is a digital media asset, stored in a digital programming file or database or other electronic format, that contains content that is for use in skills development. For example, a lesson may include language learning content that is directed to teaching or training a user in a language that is not the user's native language.

A “media presentation device” refers to an electronic device that includes a processor, a computer-readable memory device, and an output interface for presenting the audio, video, encoded data and/or text components of content from a digital media service and/or from a lesson. Examples of output interfaces include, for example, digital display devices and audio speakers. The device's memory may contain programming instructions in the form of a software application that, when executed by the processor, causes the device to perform one or more operations according to the programming instructions. Examples of media presentation devices include personal computers, laptops, tablets, smartphones, media players, voice-activated digital home assistants and other Internet of Things devices, wearable virtual reality headsets and the like.

This document describes an innovative system and technological processes for developing material for use in content-based learning, such as language learning. Content-based learning is organized around the content that a learner consumes. By repurposing content, for example news intended for broadcast, to drive learning, the system may lead to improved efficacy in acquisition and improved proficiency in performance in the skills to which the system is targeted.

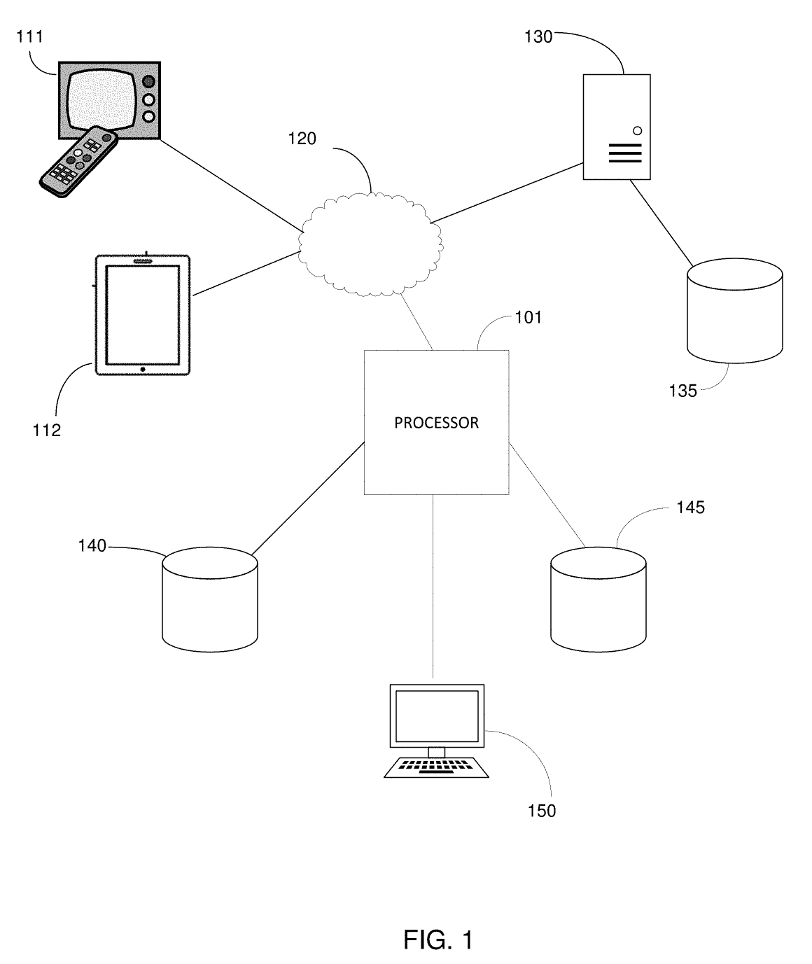

FIG. 1 illustrates a system that may be used to generate lessons that are contextually relevant to content from one or more digital programming files. The system may include a central processing device 101, which is a set of one or more processing devices and one or more software programming modules that the processing device(s) execute to perform the functions of this description. Multiple media presentation devices such as smart televisions 111 or computing devices 112 are in direct or indirect communication with the processing device 101 via one or more communication networks 120. The media presentation devices receive digital programming files in downloaded or streaming format and present the content associated with those digital files to users of the service. Optionally, to view videos or hear audio content, each media presentation device may include a video presentation engine configured to cause a display device of the media presentation device to output a video served by a remote video server, and/or it may include an audio content presentation engine configured to cause a speaker of the media presentation device to output an audio stream served by a remote audio file server.

Any number of media delivery services may contain one or more digital media servers 130 that include processors, communication hardware and a library of digital programming files that the servers send to the media presentation devices via the network 120. The digital programming files may be stored in one or more data storage facilities 135. A digital media server 130 may transmit the digital programming files in a streaming format, so that the media presentation devices present the content from the digital programming files as the files are streamed by the server 130. Alternatively, the digital media server 130 may make the digital programming files available for download to the media presentation devices.

The system also may include a data storage facility containing content analysis programming instructions 140 that are configured to cause the processor to serve as a content analysis engine. The content analysis engine will extract text corresponding to words spoken in the video or audio of a digital video or audio file, or words appearing in a digital document such as a web page. In some embodiments, the content analysis engine will identify a language of the extracted text, a named entity in the extracted text, and one or more parts of speech in the extracted text.

In some embodiments, the content analysis engine will identify and extract one or more discrete sentences (each, a single sentence) from the extracted text, or it may extract phrases, clauses and other sub-sentential units as well as super-sentential units such as dialog turns, paragraphs, etc. To do this, if the file is a digital document file, the system may parse sequential strings of text and look for a start indicator (such as a capitalized word that follows a period, which may signal the start of a sentence or paragraph) and an end indicator (such as ending punctuation, such as a period, exclamation point or question mark to end a sentence, and which may signal the end of a paragraph if followed by a carriage return). In a digital audio file or digital video file, the system may analyze an audio track of the video file in order to identify pauses in the audio track having a length that at least equals a length threshold. A “pause” will in one embodiment be a segment of the audio track having a decibel level that is at or below a designated threshold decibel level. The system will select one of the pauses and an immediately subsequent pause in the audio track. In other embodiments the segmentation may happen via non-speech regions (e.g. music or background noise) or other such means. The system will process the content of the audio track that is present between the selected pause and the immediately subsequent pause to identify text associated with the content, and it will select the identified text as the single sentence. Alternatively, the content analysis engine may extract discrete sentences from an encoded data component. If so, the content analysis engine may parse the text and identify discrete sentences based on sentence formatting conventions such as those described above. For example, a group of words that is between two periods may be considered to be a sentence.

The system also may include a data storage facility containing lesson generation programming instructions 145 that are configured to cause the processor to serve as a lesson generation engine. The lesson generation engine will automatically generate a set of questions for a lesson associated with the language.

In various embodiments the lesson may include set of prompts. For at least one of the prompts, a named entity that was extracted from the content will be part of the prompt or a response to the prompt. Similarly, one or more words that correspond to the extracted part of speech may be included in a prompt or in the response to the prompt. In other embodiments the set of prompts includes a prompt in which content of the single sentence is part of the prompt or the expected answer to the prompt.

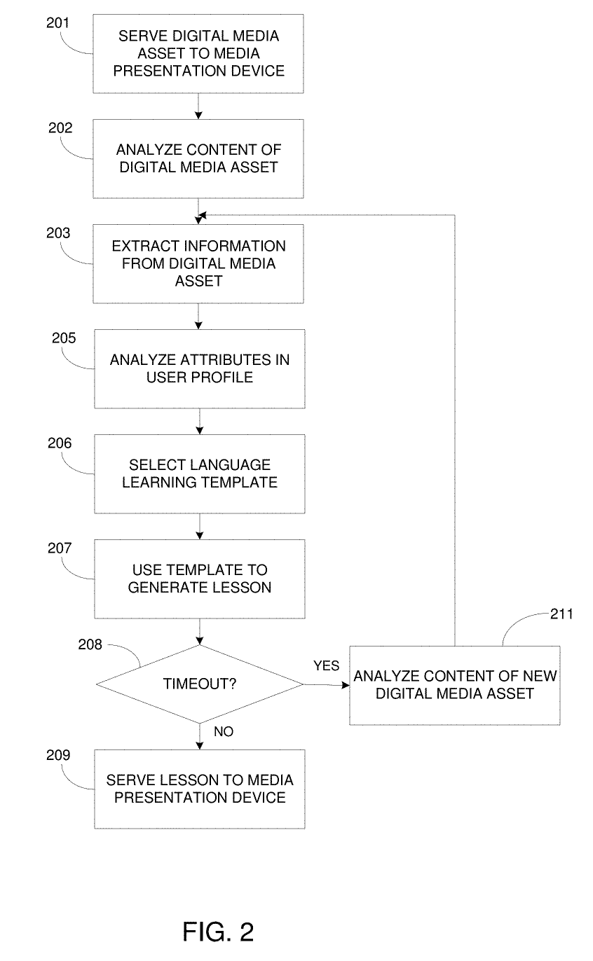

In some embodiments, prior to performing text extraction, the content analysis engine may first determine whether the digital programming file satisfies one or more screening criteria for objectionable content. The system may require that the digital programming file satisfy the screening criteria before it will extract text and/or use the digital programming file in generation of a lesson. Example procedures for determining whether a digital programming file satisfies screening criteria will be described below in the discussion of FIG. 2.

Optionally, the system may include an administrator computing device 150 that includes a user interface to view and edit any component of a lesson before the lesson is presented to a user. Ultimately, the system will cause a user interface of a user's media presentation device (such as a user interface of the computing device 112) to output the lesson to a user. One possible format is a format by which the user interface outputs the prompts one at a time, a user may enter a response to each prompt, and the user interface outputs a next prompt after receiving each response.

FIG. 2 is a process flow diagram of various elements of an embodiment of a learning system that automatically generates and presents a learning lesson that is relevant to a digital media asset that an audience member is viewing or recently viewed. In this example, the lesson is a language learning lesson. In an embodiment, when a digital media server serves 201 (or before the digital media server serves) a digital programming file (also referred to as a “digital media asset”) to an audience member's media presentation device, the system will analyze content 202 of the digital programming file to identify suitable information to use in a lesson. The information may include, for example, one or more topics, one or more named entities identified by named entity recognition (which will be described in more detail below), and/or an event from the analyzed content. The analysis may be performed by a system of the digital media server or a system associated with the digital media server, or it may be performed by an independent service that may or may not be associated with the digital media server (such as a service on the media presentation device or a third party service that is in communication with the media presentation device).

The system may extract this information 203 from the content using any suitable content analysis method. For example, the system may process an audio track of the video with a speech-to-text conversion engine to yield text output, and then parse the text output to identify the language of the text output, the topic, the named entity, and/or the one or more parts of speech. Alternatively, the system may process an encoded data component that contains closed captions by decoding the encoded data component, extracting the closed captions, and parsing the closed captions to identify the language of the text output, the topic, the named entity, and/or the one or more parts of speech. Suitable engines for assisting with these tasks include the Stanford Parser, the Stanford CoreNLP Natural Language Processing ToolKit (which can perform named entity recognition or “NER”), and the Stanford Log-Linear Part-of-Speech Tagger, the Dictionaries API (available for instance from Pearson). Alternatively, the NER can be programmed directly via various methods known in the field, such as finite-state transducers, conditional random fields or deep neural networks in a long short term memory (LSTM) configuration. One novel contribution to NER extraction is that the audio or video corresponding to the text may provide additional features, such as voice inflections, human faces, maps, etc. time-aligned with the candidate text for the NER. These time-aligned features are used in a secondary recognizer based on spatial and temporal information implemented as hidden Markov model, a conditional random field, a deep neural network or other methods. A meta-combiner, which votes based on the strength of the sub-recognizers (from text, video and audio), may produce the final NER output recognition. To provide additional detail, a conditional random field takes the form of:

$$p ( y \vert \vec{x} ) = \frac{1}{Z ( \vec{x} )} exp ( θ + {\sum }_{j = 1}^{K} {θ}_{y , j} ( \vec{x} ) )$$

yielding the probability that there is a particular NER y given the input features in the vector x. And a meta-combiner does weighted voting from individual extractors as follows:

$$P ( y \vert {\vec{x}}_{1} , … {\vec{x}}_{n} ) = {w}_{j} { max}_{{y}_{i}} ( p ( {y}_{i} \vert {\vec{x}}_{i} ) ) ,$$

where w is the weight (confidence) of each extractor.

Optionally, the system also may access a profile for the audience member to whom the system presented the digital media asset and identify one or more attributes of the audience member 205. Such attributes may include, for example, geographic location, native language, preference categories (i.e., topics of interest), services to which the user subscribes, social connections, and other attributes. When selecting a lesson template 206, if multiple templates are available for the event the system may select one of those templates having content that corresponds to the attributes of the audience member, such as a topic of interest. The measurement of correspondence may be done using any suitable algorithm, such as selection of the template having metadata that matches the most of the audience member's attributes. Optionally, certain attributes may be assigned greater weights, and the system may calculate a weighted measure of correspondence.

After selecting the language learning template 206, the system automatically generates a lesson 207 by automatically generating questions or other exercises in which the exercise is relevant to the topic, and/or in which the named entity or part of speech is part of the question, answer or other component of the exercise. The system may obtain a template for the exercise from a data storage facility containing candidate exercises such as (1) questions and associated answers, (2) missing word exercises, (3) sentence scramble exercises, and (4) multiple choice questions. The content of each exercise may include blanks in which named entities, parts of speech, or words relevant to the topic may be added. Optionally, if multiple candidate questions and/or answers are available, the system also may select a question/answer group having one or more attributes that correspond to an attribute in the profile (such as a topic of interest) for the user to whom the digital lesson will be presented.

Optionally, in some embodiments before serving the lesson to the user the system may present the lesson (or any question/answer set within the lesson) to an administrator computing device on a user interface that enables an administrator to view and edit the lesson (or lesson portion).

The system will then cause a digital media server to serve the lesson to the audience member's media presentation device 209. The digital media server that serves the lesson may be the same one that served the digital video asset, or it may be a different server.

As noted above, when analyzing content of a digital programming file, the system may determine whether the digital programming file satisfies one or more screening criteria for objectionable content. The system may require that the digital programming file satisfy the screening criteria before it will extract text and/or use the digital programming file in generation of a lesson. If the digital programming file does not satisfy the screening criteria—for example, if a screening score generated based on an analysis of one or more screening parameters exceeds a threshold—the system may skip that digital programming file and not use its content in lesson generation. Examples of such screening parameters may include parameters such as:
requiring that the digital programming file originate from a source that is a known legitimate source (as stored in a library of sources), such as a known news reporting service or a known journalist;
requiring that the digital programming file not originate from a source that is designated as blacklisted or otherwise suspect (as stored in a library of sources), such as a known “fake news” publisher;
requiring that the digital programming file originate from a source that is of at least a threshold age;
requiring that the digital programming file not contain any content that is considered to be obscene, profane or otherwise objectionable based on one or more filtering rules (such as filtering content containing one or more words that a library in the system tags as profane);
requiring that content of the digital programming file be verified by one or more registered users or administrators.

The system may develop an overall screening score using any suitable algorithm or trained model. As a simple example, the system may assign a point score for each of the parameters listed above (and/or other parameters) that the digital programming file fails to satisfy, sum the point scores to yield an overall screening score, and only use the digital programming file for lesson generation if the overall screening score is less than a threshold number. Other methods may be used, such as machine learning methods disclosed in, for example, U.S. Patent Application Publication Number 2016/0350675 filed by Laks et al., and U.S. Patent Application Publication Number 2016/0328453 filed by Galuten, the disclosures of which are fully incorporated into this document by reference.

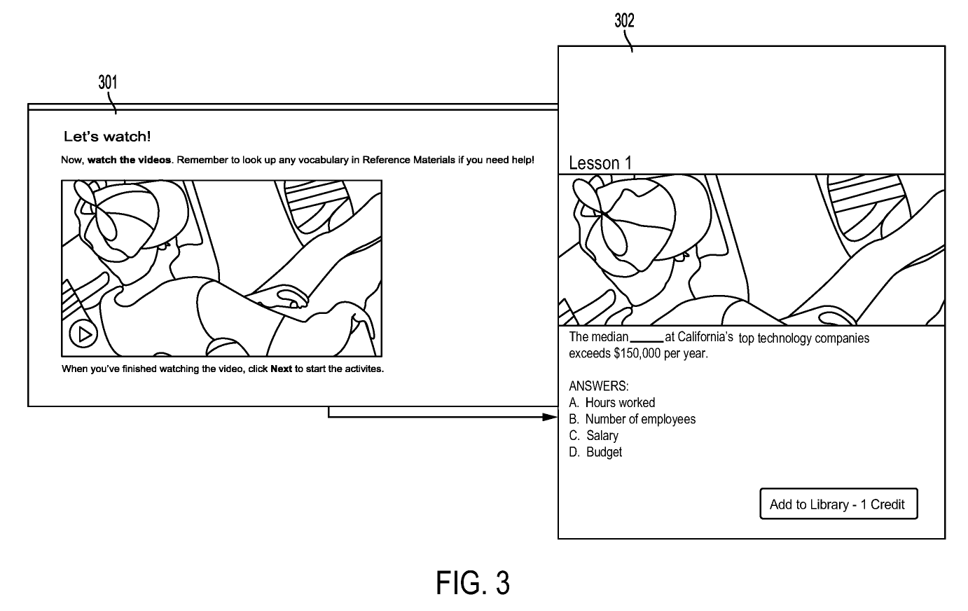

FIG. 3 illustrates an example where a digital video 301 is presented to a user via a display device of a media presentation device. The system then generates language learning and/or other lessons 302 and presents them to the user via the display. In the example of FIG. 3, the digital video 301 is a video from the business section of a news website. The system may analyze the text spoken in the video using speech-to-text analysis, process an accompanying closed captioning track or use other analysis methods to extract a topic (technology), one or more named entities (e.g., Facebook or Alphabet) from the text, and one or more parts of speech (e.g., salary, which is a noun). The system may then incorporate the named entity or part of speech into one or more question/answer sets or other exercises. It may use the question/answer pair in the lesson 302. Optionally, the system may generate lesson learning exercises that also contain content that the system determines will be relevant to the user based on user attributes and/or a topic of the story. In this example, the system generates a multiple-choice question in which the part of speech (salary, a noun) is converted to a blank in the prompt.

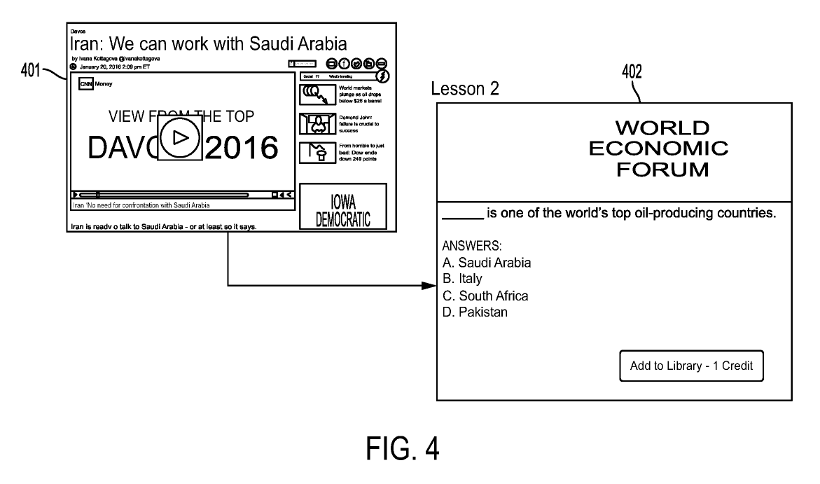

As another example, a named entity may be used as an answer to a multiple choice question. FIG. 4 illustrates an example in which a video 401 has been parsed to generate a lesson 402 that includes a multiple-choice question. A named entity (Saudi Arabia) has been replaced with a blank in the prompt (i.e., the question). The named entity is one of the correct answers to the question. The other candidate answers are selected as foils, which are other words (in this example, other named entities) that are associated with an entity category in which the named entity is categorized (in this example, the category is “nation”).

The lesson generation engine also may generate foils for vocabulary words. For example, the lesson generation engine may generate a correct definition and one or more files that are false definitions, in which each foil is an incorrect answer that includes a word associated with a key vocabulary word that was extracted from the context. To generate foils, the system may select one or more words from the content source that are based on the part of speech of a word in the definition such as plural noun, adjective (superlative), verb (tense) or other criteria, and include those words in the foil definition.

Returning to FIG. 2, before or when presenting a lesson to an audience member, optionally the system may first apply a timeout criterion 208 to determine whether the lesson is still relevant to the digital programming file. The timeout criterion may be a threshold period of time after the audience member's media presentation device outputs the lesson to the audience member, a threshold period of time after the audience member viewed and/or listened to the digital programming file, a threshold period of time corresponding to a length of time after the occurrence of the news event with which the content of the digital programming file is related, or other threshold criteria. If the threshold has been exceeded, the system may then analyze a new digital programming file 211 and generate a new lesson component that is relevant to the content of the new digital programming file using processes such as those described above. The system also may analyze the user's response and generate a new lesson component based on the user's responses to any previously-presented lesson components. For example, the system may analyze a set of responses from a user to determine a language (or other skill) proficiency score for the user, and it may generate and present the user with a new question that has a skill level that corresponds to the proficiency score.

Thus, the systems and methods described in this document may leverage and repurpose content into short, pedagogically structured, topical, useful and relevant lessons for the purpose of learning and practice of language and/or other skills on a global platform that integrates the content with a global community of users. In some embodiments, the system may include an ability to communicate between users that includes, but is not limited to, text chat, audio chat and video chat. In some situations, the lessons may include functionality for instruction through listening dictation, selection of key words for vocabulary study and key grammatical constructions (or very frequent collocations).

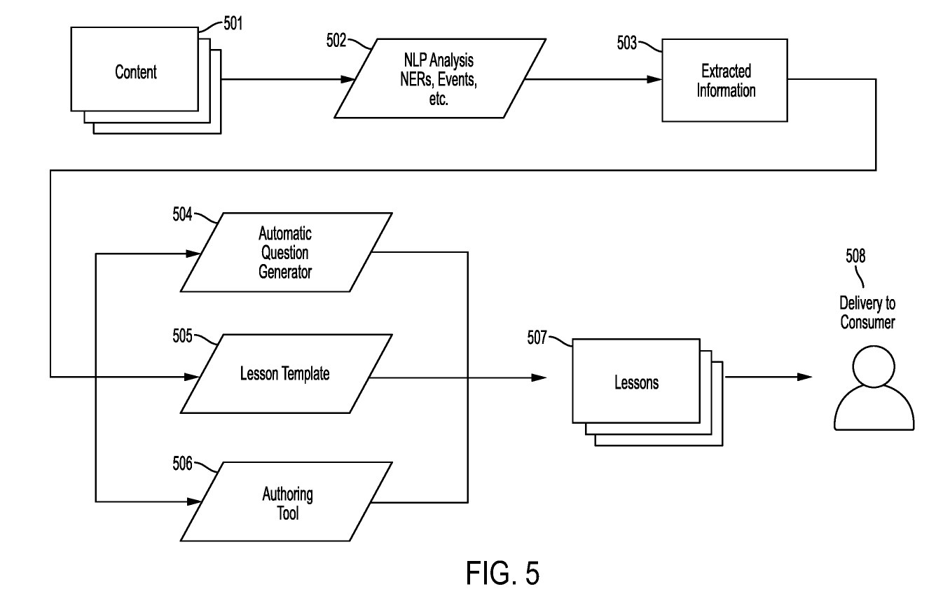

FIG. 5 illustrates an additional process flow. Content 501 of a video (including accompanying text and/or audio that provides information about current news events, business, sports, travel, entertainment, or other consumable information) or other digital programming file will include text in the form of words, sentences, paragraphs, and the like. The extracted text may be integrated into a Natural Language Processing analysis methodology 502 that may include NER, recognition of events, and key word extraction. NER is a method of information extraction that works by locating and classifying elements in text into pre-defined categories (each, an “entity”) that is used to identify a person, place or thing. Examples of entities include the names of persons, organizations, locations, expressions of times, quantities, monetary values, percentages, etc. Events are activities or things that occurred or will occur, such as sporting events (e.g., basketball or football games, car or horse races, etc.), news events (e.g., elections, weather phenomena, corporate press releases, etc.), or cultural events (e.g., concerts, plays, etc.). Key word extraction is the identification of key words (which may include single words or groups of words—i.e., phrases) that the system identifies as “key” by any now or hereafter known identification process such as document classification and/or categorization and word frequency differential. The key word extraction process may look not only at single words that appear more frequently than others, but also at semantically related words, which the system may group together and consider to count toward the identification of a single key word.

The resulting output (extracted information 503) may be integrated into several components of a lesson generator, which may include components such as an automatic question generator 504, lesson template 505 (such as a rubric of questions and answers with blanks to be filled in with extracted information and/or semantically related information), and one or more authoring tools 506. Optionally, before using any material to generate a lesson, the lesson generator may ensure that the content analysis engine has first ensured that the material satisfies one or more screening criteria for objectionable content, using screening processes such as those described above.

The automatic question generator 504 creates prompts for use in lessons based on content of the digital media asset. (In this context, a question may be an actual question, or it may be a prompt such as a fill-in-the-blank or true/false sentence.) For example, after the system extracts the entities and events from content of the digital programming file, it may: (1) rank events by how central they are to the content (e.g. those mentioned more than once, or those in the lead paragraph are more central and thus ranked higher); (2) cast the events into a standard template, via dependency parsing or a similar process, thus producing, for example: (a) Entity A did action B to entity C in location D, or (b) Entity A did action B which resulted in consequence E. The system may then (3) automatically create a fill-in-the-blank, multiple choice or other question based on the standard template. As an example, if the digital media asset content was a news story with the text: “Russia extended its bombing campaign to the town of Al Haddad near the Turkmen-held region in Syria in support of Assad' s offensive,” then a multiple choice or fill-in-the-blank automatically generated question might be “Russia bombed in Syria.” Possible answers to the question may include: (a) Assad; (b) Al Haddad; (c) Turkmen; and/or (d) ISIS, in which one of the answers is the correct named entity and the other answers are foils. In at least some embodiments, the method would not generate questions for the parts of the text that cannot be mapped automatically to a standard event template.

The lesson template 505 is a digital file containing default content, structural rules, and one or more variable data fields that is pedagogically structured and formatted for language learning. The template may include certain static content, such as words for vocabulary, grammar, phrases, cultural notes and other components of a lesson, along with variable data fields that may be populated with named entities, parts of speech, or sentence fragments extracted from a video.

The authoring tool 506 provides for a post-editing capability to refine the output based on quality control requirements for the lessons. The authoring tool 506 may include a processor and programming instructions that outputs the content of a lesson to an administrator via a user interface (e.g., a display) of a computing device, with input capabilities that enable the administrator to modify, delete, add to, or replace any of the lesson content. The modified lesson may then be saved to a data file for later presentation to an audience member 508.

Lesson production yields lessons 507 that are then either fully automated or partially seeded for final edits.

The system may then apply matching algorithms to customer/user profile data and route the lessons to a target individual user for language learning and language practice. Example algorithms include those described in United States Patent Application Publication Number 2014/0222806, titled “Matching Users of a Network Based on Profile Data”, filed by Carbonell et al. and published Aug. 7, 2014.

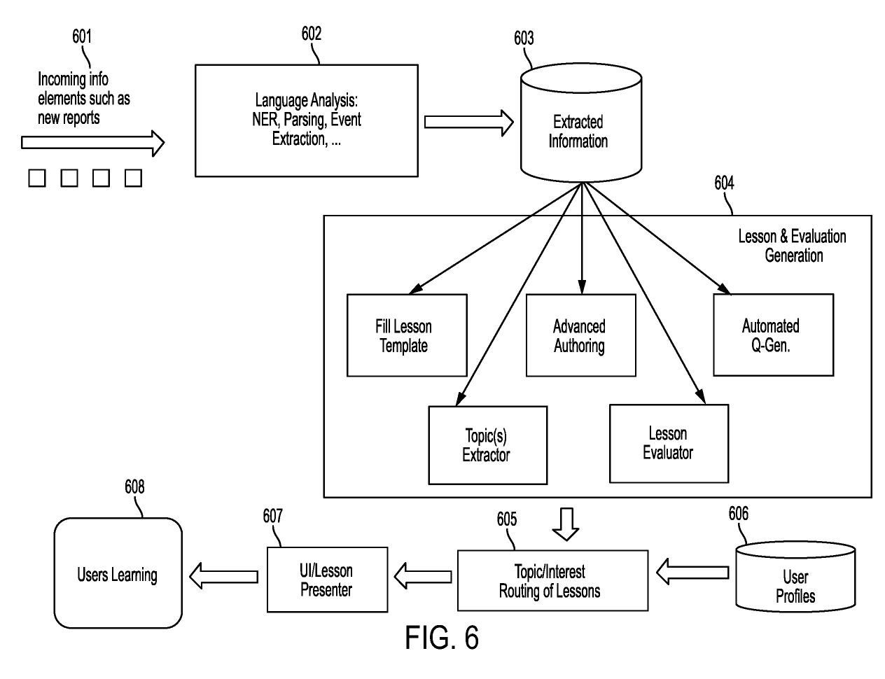

FIG. 6 illustrates additional details of an example of an automated lesson generation process, in this case focusing on the actions that the system may take to automatically generate a lesson. As with the previous figure, here the system may receive content 601, which may include textual, audio and/or video content. In one embodiment such content includes news stories. In other embodiments the content may include narratives such as stories, in another embodiment the content may include specially produced educational materials, and in other embodiments the content may include different subject matter.

The system in FIG. 6 uses automated text analysis techniques 602, such as classification/categorization to extract topics such as “sports” or “politics” or more refined topics such as “World Series” or “Democratic primary.” The methods used for automated topic categorization may be based the presence of keywords and key phrases. In addition or alternatively, the methods may be machine learning methods trained from topic-labeled texts, including decision trees, support-vector machines, neural networks, logistic regression, or any other supervised or unsupervised machine learning method. Another part of the text analysis may include automatically identifying named entities in the text, such as people, organizations and places. These techniques may be based on finite state transducers, hidden Markov models, conditional random fields, deep neural networks with LSTM methods or such other techniques as a person of skill in the art will understand, such as those discussed above or other similar processes and algorithms from machine learning. Another part of the text analysis may include automatically identifying and extracting events from the text such as who-did-what-to-whom (for example, voters electing a president, or company X selling product Y to customers Z). These methods may include, for example, those used for identifying and extracting named entities, and also may include natural language parsing methods, such as phrase-structure parsers, dependency parsers and semantic parsers.

In 604, the system addresses creation of lessons and evaluations based on the extracted information. These lessons can include highlighting/repeating/re-phrasing extracted content. The lessons can also include self-study guides based on the content. The lessons can also include automatically generated questions based on the extracted information (such as “who was elected president”, or “who won the presidential election”), presented in free form, in multiple-choice selections, as a sentence scramble, as a fill-in-the-blank prompt, or in any other format understandable to a student. Lessons are guided by lesson templates that specify the kind of information, the quantity, the format, and/or the sequencing and the presentation mode, depending on the input material and the level of difficulty. In one embodiment, a human teacher or tutor interacts with the extracted information 603, and uses advanced authoring tools to create the lesson. In another embodiment the lesson creation is automated, using the same resources available to the human teacher, plus algorithms for selecting and sequencing content to fill in the lesson templates and formulate questions for the students. These algorithms are based on programmed steps and machine learning-by-observation methods that replicate the observed processes of the human teachers. Such algorithms may be based on graphical models, deep neural nets, recurrent neural network algorithms or other machine learning methods.

Finally, lessons are coupled with extracted topics and matched with the profiles of users 606 (students) so that the appropriate lessons may be routed to the appropriate users 605. The matching process may be done by a similarity metric, such as dot-product, cosine similarity, inverse Euclidean distance, or any other well-defined matching methods of interests vs. topics, such as the methods taught in U.S. Patent Application Publication Number 2014/0222806, titled “Matching Users of a Network Based on Profile Data”, filed by Carbonell et al. and published Aug. 7, 2014. Each lesson may then be presented to the user 607 via a user interface (e.g., display device) of the user's media presentation device so that the user is assisted in learning 608 a skill that is covered by the lesson.

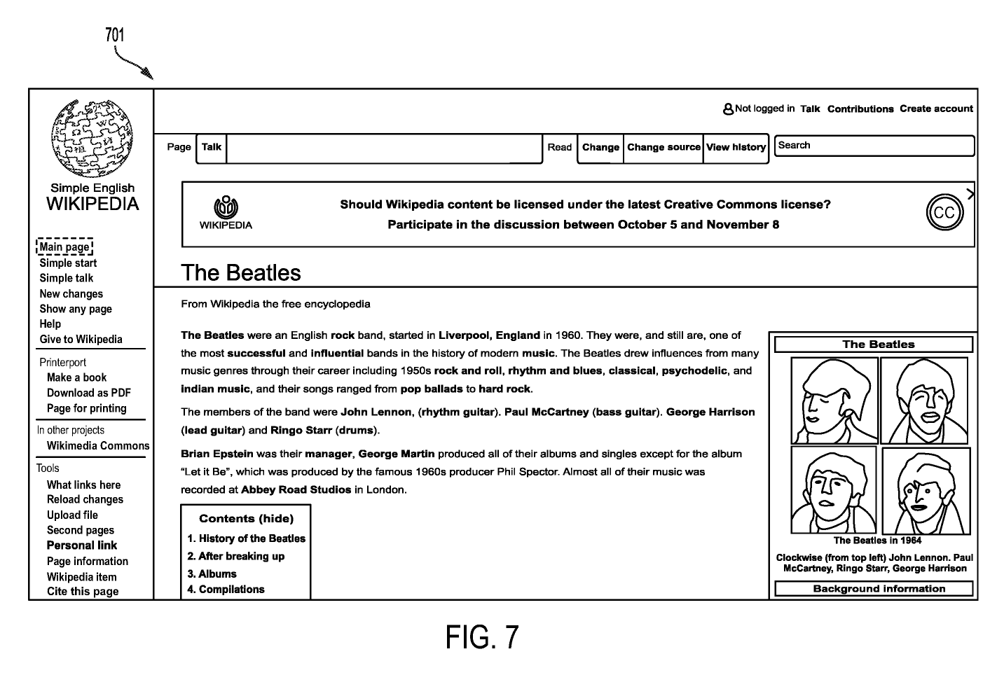

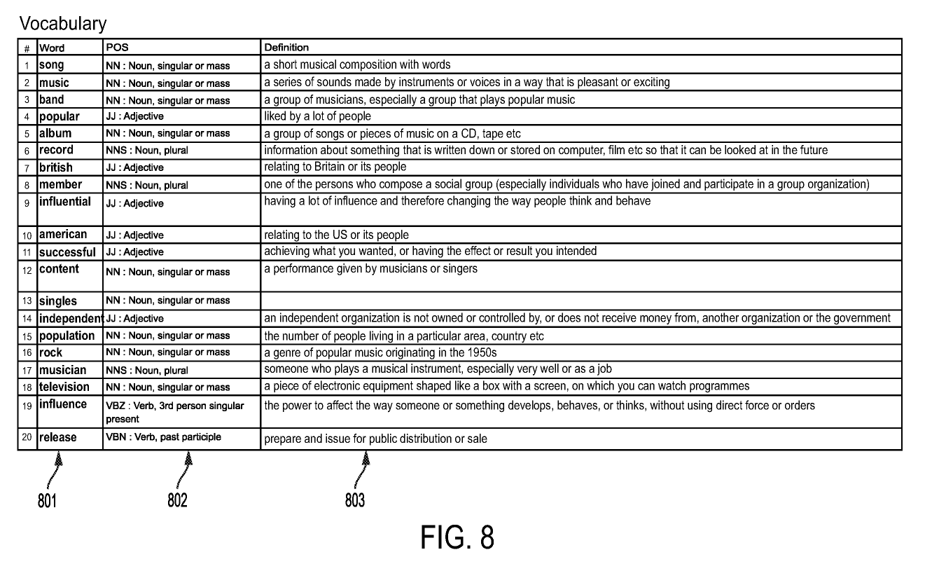

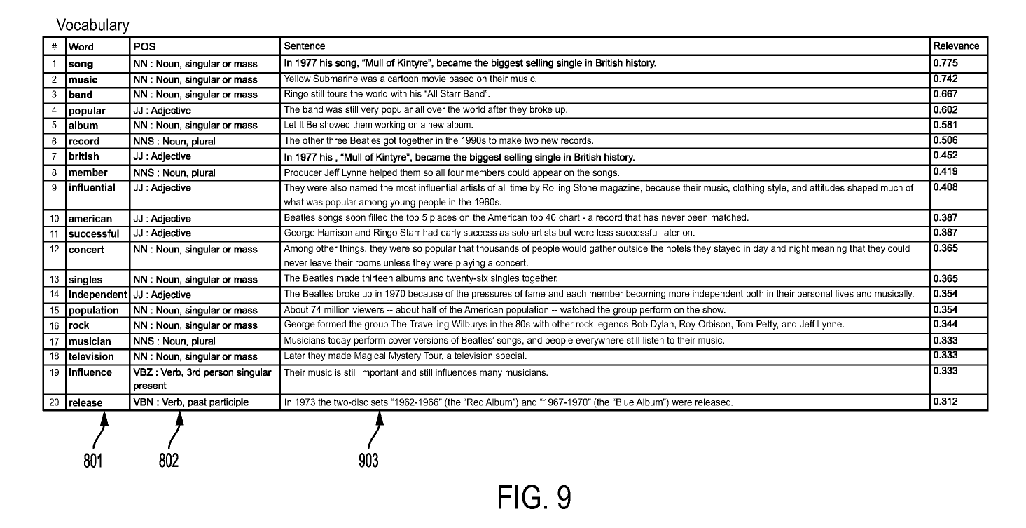

FIGS. 7-11 illustrate an example of how a system may implement the steps described above in FIG. 6. FIG. 7 illustrates an example of content 701 from a digital programming file that may be displayed, in this case a page from Wikipedia containing information about The Beatles. Referring to FIGS. 8 and 9, in a vocabulary processing process the system may generate a list of most frequently-appearing words 801 in the content, and it may attach a part of speech (POS) 802 and definition 803 to each word of the list, using part-of-speech tagging and by looking up definitions in a local or online database. The system may require that the list include a predetermined number of most frequently-appearing words, that the list include only words that appear at least a threshold number of times in the content, that the list satisfy another suitable criterion or a combination of any of these. To assist a human administrator in evaluating a potential lesson, the system also may extract some or all of the sentences 903 in which each identified word appears.

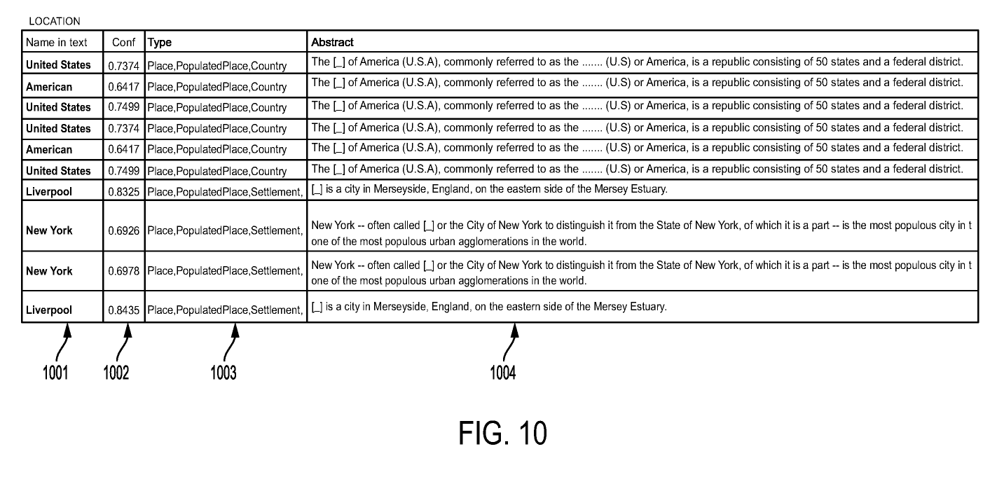

In FIG. 10, the system may narrow down its set of most frequently-occurring words to include only words that correspond to a particular category, in this example words denoting location 1001 (or to another form of person, place or thing). The system may assign a category type 1003 and definition or abstract 1004 to each word as described in the previous example, optionally also with a confidence level indicator 1002 indicating a measure of degree of confidence that each word is properly included in the category.

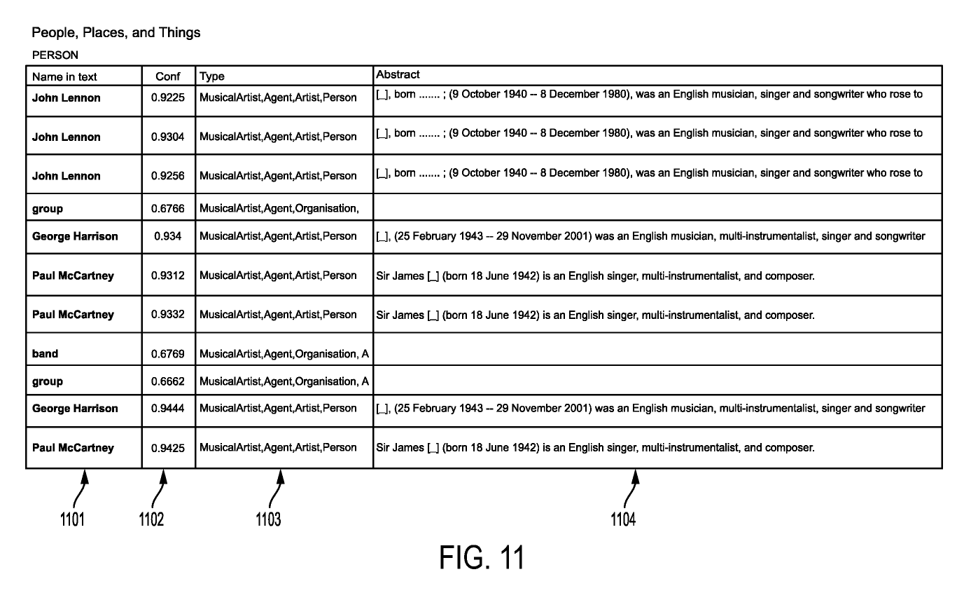

FIG. 11 illustrates an additional selection of words corresponding to a category, in this case words corresponding to a person, place or thing 1101. The system may assign a category type 1103 and definition 1104 to each word as described in the previous example, optionally also with a confidence level indicator 1102 indicating a measure of degree of confidence that each word is properly included in the category.

In an example, to extract vocabulary words, named entities, or other features from content, the system may use an application programming interface (API) such as Dandelion to extract named entities from a content item, as well as information and/or images associated with each extracted named entity. The system may then use this information to generate questions, along with foils based on named entity type.

As another example, to produce information such as that shown in FIGS. 8 and 9, the system may break content into sentences and words using any suitable tool such as the Stanford CoreNLP toolkit. The system may tag each word of the content with a part of speech. For each noun or verb having multiple possible definitions, the system may perform word sense determination—i.e., determine the likely sense of each noun and verb—using tools such as WordNet (from Princeton University) or Super Senses. Example senses that may be assigned to a word are noun.plant, noun.animal, noun.event, verb.motion, or verb.creation. The system may then discard common words like “a”, “the”, “me”, etc.

The system may obtain the definition of each remaining word through any suitable process, such as by looking the word up in a local or external database, such as a local lesson auditor database, and extracting the definition from the database.

The system may also resolve words to proper lemma (base form). For example, the base form of the words runner and running is “run”. Words like “accord” are problematic because the base form of according when used in the phrase “according to” is accord, which has a completely different meaning. Morphological normalization to lemma form can be done by an algorithm where, for example, the system identifies and removes suffixes from each word and adds base-level endings according to one or more rules. Example base-level ending rules include:
(1) the -s rule (i.e., remove an ending “s”); example: “pencils” -s --> “pencil”,
(2) the -ies+y rule (i.e., replace an ending “ies” with “y”); example: “countries” -ies +y -->“country”,
(2) the -ed rule (i.e., replace an ending “ed” with “e”); example: “evaporated” -ed -->“evaporate”).

The system may also store an exception table in memory for a relatively small number of irregular word forms that are handled by substitutions (e.g. “threw” -->“throw”, “forgotten” -->“forget”, etc.). In an embodiment, the system may first check the exception table, and if the word is not there, then process the other rules in a fixed order and use the first rule whose criteria matches the word (e.g., ends with “s”). If none of the rules' criteria match the word, the word will be left unchanged.

The system may assign a relevancy to each word based on: (i) whether the system was able to define it (from previous step); (ii) the number of times that the word appeared in the source material; and (iii) the number of syllables in the word, with bigger words—i.e., words with more syllables—generally considered to be more important than words with relatively fewer syllables. An example process by which the system may do this is to:
(1) obtain the lemma (base form) for each word in the source content (optionally after discarding designated common terms such as “a” and “the”);
(2) count the number of unique lemmas in the system (lc);
(3) identify the maximum lemma count max(lc) (i.e., the number of times that the most frequently-occurring lemma appears);
(4) count the number of syllables in the word to which relevancy is being assigned sc (either through analysis or by using a lookup data set);
(5) count the maximum syllable count max(sc) (i.e., the maximum number of syllables that appear in any word in the source); and
(6) determine the relevancy for each word as:

relevancy=0.7 (lc/max(lc))+0.3(sc/max(sc)).

Other weights may be used for each of the ratios, and other algorithms may be used to determine relevancy.

Optionally, the system may include additional features when generating a lesson. For example, the system may present the student user with a set of categories, such as sports, world news, or the arts, and allow the user to select a category. The system may then search its content server or other data set to identify one or more digital programming files that are tagged with the selected category. The system may present indicia of each retrieved digital programming file to the user so that the user can select any of the programming files for viewing and/or lesson generation. The system will then use the selected digital programming files as content sources for lesson generation using the processes described above.

Example lessons that the system may generate include:

(1) Vocabulary lessons, in which words extracted from the text (or variants of the word, such as a different tense of the word) are presented to a user along with a correct definition and one or more distractor definitions (also referred to as “foil definitions”) so that the user may select the correct definition in response to the prompt. The distractor definitions may optionally contain content that is relevant to or extracted from the text.

(2) Fill-in-the-blank prompts, in which the system presents the user with a paragraph, sentence or sentence fragment. Words extracted from the text (or variants of the word, such as a different tense of the word) must be used to fill in the blanks.

(3) Word family questions, in which the system takes one or more words from the digital programming file and generates other forms of the word (such as tenses). The system may then identify a definition for each form of the word (such as by retrieving the definition from a data store) and optionally one or more distractor definitions and ask the user to match each variant of the word with its correct definition.

(4) Opposites, in which the system outputs a word from the text and prompts the user to enter or select a word that is an opposite of the presented word. Alternatively, the system may require the user to enter a word from the content that is the opposite of the presented word.

(5) Sentence scrambles, in which the system presents a set of words that the user must rearrange into a logical sentence. Optionally, some or all of the words may be extracted from the content.

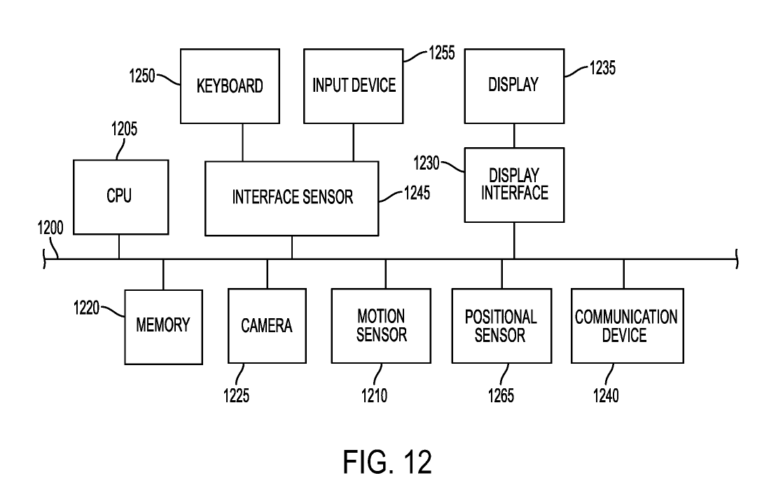

FIG. 12 depicts an example of internal hardware that may be included in any of the electronic components of the system, an electronic device, or a remote server. An electrical bus 1200 serves as an information highway interconnecting the other illustrated components of the hardware. Processor 1205 is a central processing device of the system, i.e., a computer hardware processor configured to perform calculations and logic operations required to execute programming instructions. As used in this document and in the claims, the terms “processor” and “processing device” are intended to include both single-processing device embodiments and embodiments in which multiple processing devices together or collectively perform a process. Similarly, a server may include a single processor-containing device or a collection of multiple processor-containing devices that together perform a process. The processing device may be a physical processing device, a virtual device contained within another processing device (such as a virtual machine), or a container included within a processing device.

Read only memory (ROM), random access memory (RAM), flash memory, hard drives and other devices capable of storing electronic data constitute examples of memory devices 1220. Except where specifically stated otherwise, in this document the terms “memory,” “memory device,” “data store,” “data storage facility” and the like are intended to include single device embodiments, embodiments in which multiple memory devices together or collectively store a set of data or instructions, as well as individual sectors within such devices.

An optional display interface 1230 may permit information from the bus 1200 to be displayed on a display device 1235 in visual, graphic or alphanumeric format. An audio interface and audio output (such as a speaker) also may be provided. Communication with external devices may occur using various communication devices 1240 such as a transmitter and/or receiver, antenna, an RFID tag and/or short-range or near-field communication circuitry. A communication device 1240 may be attached to a communications network, such as the Internet, a local area network or a cellular telephone data network.

The hardware may also include a user interface sensor 1245 that allows for receipt of data from input devices such as a keyboard 1250, a mouse, a joystick, a touchscreen, a remote control, a pointing device, a video input device and/or an audio input device 1255. Data also may be received from a video capturing device 1225. A positional sensor 1265 and motion sensor 1210 may be included to detect position and movement of the device. Examples of motion sensors 1210 include gyroscopes or accelerometers. Examples of positional sensors 1265 include a global positioning system (GPS) sensor device that receives positional data from the external GPS network.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A digital media content extraction, lesson generation and presentation system, comprising:
a data store portion containing digital programming files, each of which contains a digital media asset;
a data store portion containing a library of learning templates;
a digital media server configured to transmit at least a subset of the digital programming files to media presentation devices via a communication network; and
a computer-readable medium containing programming instructions that are configured to cause a processor to automatically generate a lesson by:
automatically analyzing content of a digital media asset that is being presented or that the digital media server will present to a user's media presentation device for presentation to the user, wherein the analyzing includes:
using named entity recognition to extract a named entity from the analyzed content, and
extracting an event from the analyzed content,
accessing the library of learning templates and selecting a template that is associated with the event,
populating the learning template with text associated with the named entity to generate a lesson, and
causing the digital media server to transmit the lesson to the user's media presentation device for presentation to the user.

2. The system of claim 1, further comprising:
a data store portion containing profiles for a plurality of users; and
wherein the instructions to select the learning template that is associated with the event are configured to cause the processor to select a learning template having one or more attributes that correspond to an attribute in the profile for the user to whom the lesson will be presented.

3. The system of claim 1, further comprising:
a data store portion containing profiles for a plurality of users; and
wherein the instructions to select the learning template that is associated with the event are configured to cause the processor to populate the learning template with text having one or more attributes that correspond to an attribute in the profile for the user to whom the lesson will be presented.

4. The system of claim 1, wherein the instructions to cause the digital media server to transmit the lesson are configured to cause the digital media server to do so no later than a threshold period of time after the user's media presentation device outputs the digital media asset to the user.

5. The system of claim 1, wherein the instructions to cause the processor to analyze content of the digital media asset also comprise instructions to:
for each digital media asset for which content is analyzed, before extracting the named entity and event, analyzing the content of that digital media asset to determine whether the content satisfies one or more screening criteria for objectionable content; and
only extracting the named entity and event from that digital media asset if the content satisfies the one or more screening criteria, otherwise not using that digital media asset to generate the lesson.

6. A digital media content extraction and lesson generation system, comprising:
a data store portion containing a library of learning templates;
a processor; and
a computer-readable medium containing programming instructions that are configured to cause the processor to automatically generate a lesson by:
automatically analyzing content of a digital media asset that a digital media server is presenting or has presented to a user's media presentation device for presentation to the user, wherein the analyzing includes:
using named entity recognition to extract a named entity from the analyzed content, and
extracting an event from the analyzed content,
accessing the library of learning templates and selecting a learning template that is associated with the event,
populating the learning template with text associated with the named entity to generate a lesson, and
causing the lesson to the presented on or transmitted to the user's media presentation device.

7. The system of claim 6, further comprising:
a data store portion containing profiles for a plurality of users; and
wherein the instructions to select the learning template that is associated with the event are configured to cause the processor to select a learning template having one or more attributes that correspond to an attribute in the profile for the user to whom the lesson will be presented.

8. The system of claim 6, further comprising:
a data store portion containing profiles for a plurality of users; and
wherein the instructions to select the learning template that is associated with the event are configured to cause the processor to populate the learning template with text having one or more attributes that correspond to an attribute in the profile for the user to whom the lesson will be presented.

9. The system of claim 6, wherein the instructions cause the lesson to the presented on or transmitted to the user's media presentation device comprise instructions to do so no later than a threshold period of time after the user's media presentation device outputs the digital media asset to the user.

10. The system of claim 6, wherein the instructions to cause the processor to analyze content of the digital media asset also comprise instructions to:
for each digital media asset for which content is analyzed, before extracting the named entity and event, analyzing the content of that digital media asset to determine whether the content satisfies one or more screening criteria for objectionable content; and
only extracting the named entity and event from that digital media asset if the content satisfies the one or more screening criteria, otherwise not using that digital media asset to generate the lesson.

11. A system for analyzing streaming video and an associated audio or text channel and automatically generating a learning exercise based on data extracted from the channel, comprising:
a video presentation engine configured to cause a display device to output a video served by a video server;
a processing device;
a content analysis engine that includes programming instructions that are configured to cause the processing device to extract text corresponding to words spoken or captioned in the channel and identify:
a language of the extracted text, and
a topic, and
a sentence characteristic that includes a named entity or one or more parts of speech; and
a lesson generation engine that includes programming instructions that are configured to cause the processing device to:
automatically generate a learning exercise associated with the language, wherein the learning exercise includes:
at least one question that is relevant to the topic, and
at least one question or associated answer that includes information pertinent to the sentence characteristic, and
cause a user interface to output the learning exercise to a user in a format by which the user interface outputs the questions one at a time, a user may enter a response to each question, and the user interface outputs a next question after receiving each response.

12. The system of claim 11, wherein the content analysis engine that includes programming instructions that are configured to cause the processing device to extract text corresponding to words comprise programming instructions to:
process an audio component of the video with a speech-to-text conversion engine to yield a text output; and
parse the text output to identify the language of the text output, the topic, and the sentence characteristic.

13. The system of claim 11, wherein the content analysis engine that includes programming instructions that are configured to cause the processing device to extract text corresponding to words comprise programming instructions to:
process a data component of the video that contains encoded closed captions for the video;
decode the encoded closed captions to yield a text output; and
parse the text output to identify the language of the text output, the topic, and the sentence characteristic.

14. The system of claim 11, wherein the lesson generation engine also includes programming instructions that are configured to cause the processing device to:
identify a question in the set of questions that is a multiple-choice question;
designate the named entity as the correct answer to the question;
generate one or more foils so that each foil is an incorrect answer that is a word associated with an entity category in which the named entity is categorized;
generate a plurality of candidate answers for the multiple-choice question so that the candidate answers include the named entity and the one or more foils; and
cause the user interface to output the candidate answers when outputting the multiple-choice question.

15. The system of claim 11, wherein the lesson generation engine also includes programming instructions that are configured to cause the processing device to:
identify a question in the set of questions that is a true-false question; and
include the named entity in the true-false question.

16. The system of claim 11, further comprising a lesson administration engine that includes programming instructions that are configured to cause the processing device to, for any output question that is a fill-in-the-blank question:
determine whether the response received to the fill-in-the-blank question is an exact match to a correct response;
if the response received to the fill-in-the-blank question is an exact match to a correct response, output an indication of correctness and advance to a next question; and
if the response received to the fill-in-the-blank question is not an exact match to a correct response:
determine whether the received response is a semantically related match to the correct response, and
if the received response is a semantically related match to the correct response, output an indication of correctness and advance to a next question, otherwise output an indication of incorrectness.

17. The system of claim 11, further comprising additional programming instructions that are configured to cause the processing device to:
analyze a set of responses from a user to determine a language proficiency score for the user;
identify an additional video that is available at the remote video server and that has a language level that corresponds to the language proficiency score; and
cause the video presentation engine to cause a display device to output the additional video as served by the remote video server.

18. The system of claim 11, further comprising additional programming instructions that are configured to cause the processing device to:
analyze a set of responses from a user to determine a language proficiency score for the user;
generate a new question that has a language level that corresponds to the language proficiency score; and
cause the user interface to output the new question.

19. The system of claim 11, further comprising instructions to extract the named entity by performing multiple extraction methods from text, audio and/or video and use a meta-combiner to produce the named entity.

20. The system of claim 11, wherein:
the identified sentence characteristic includes both the named entity and one or more parts of speech; and
the learning exercise includes:
a question or associated answer that includes the named entity, and
a question or associated answer that includes the one or more parts of speech.

21. The system of claim 11, wherein the lesson generation engine also includes instructions that are configured to cause the processing device to, when generating the learning exercise, only using content from the channel if the content satisfies one or more screening criteria for objectionable content, otherwise not using that digital media asset to generate the learning exercise.

22. A system for analyzing streaming video and automatically generating a lesson based on data extracted from the streaming video, comprising:
a video presentation engine configured to cause a display device to output a video served by a remote video server;
a processing device;
a content analysis engine that includes programming instructions that are configured to cause the processing device to identify a single sentence of words spoken in the video; and
a lesson generation engine that includes programming instructions that are configured to cause the processing device to:
automatically generate a set of questions for a lesson, wherein the set of questions comprises a plurality of questions in which content of the identified single sentence is part of the question or the answer to the question, and
cause a user interface to output the set of questions to a user in a format by which the user interface will output the questions one at a time, a user may enter a response to each question, and the user interface will output a next question after receiving each response.

23. The system of claim 22, in which the instructions of the content analysis engine that are configured to cause the processing device to identify a single sentence of words spoken in the video comprise instructions to:
analyze an audio track of the video in order to identify a plurality of pauses in the audio track having a length that at least equals a length threshold, wherein each pause comprises a segment of the audio track having a decibel level that is at or below a decibel threshold;
select one of the pauses and an immediately subsequent pause in the audio track; and
process the content of the audio track that is present between the selected pause and the immediately subsequent pause to identify text associated with the content and select the identified text as the single sentence.
